(19) United States
(12) Patent Application Publication
(10) Pub. No.: US 2015/0073873 A1
(43) Pub. Date: Mar. 12, 2015

(54) AUTOMATED, SELF-LEARNING TOOL FOR IDENTIFYING IMPACTED BUSINESS PARAMETERS FOR A BUSINESS CHANGE-EVENT

(71) Applicant: BANK OF AMERICA CORPORATION, Charlotte, NC (US)

(72) Inventors: Corey D. Williams, Charlotte, NC (US); Amit George, Harrisburg, NC (US)

(21) Appl. No.: 14/538,587

(22) Filed: Nov. 11, 2014

Related U.S. Application Data
(63) Continuation of application No. 12/618,228, filed on Nov. 13, 2009.

(51) Int. Cl. G06N 7/00; G06Q 10/06

(52) U.S. Cl. CPC G06N 7/005; G06Q 10/06375
USPC 705/7.37

(57) ABSTRACT

Embodiments of the invention relate to systems, methods, and computer program products for identifying probable impacted business parameters, such as business applications, business teams/organizations at the onset of a business change-event, such as a business project, initiation of product/service offering or the like. Embodiments rely on analysis of historical data and architecture blueprints, driven by a predefined statistical model to determine probable impacted business parameters. Additionally, embodiments provide for determining the level-of-impact, in terms of hours and financials and/or the priority of the probable impacted business parameters. In addition, embodiments provide for automated notification of individuals and/or entities associated with the probable impacted business parameters.

### CLAIM OF PRIORITY UNDER 35 U.S.C. §120

The present invention is a continuation of U.S. patent application Ser. No. 12/618,228, entitled, “Automated, Self-Learning Tool for Identifying Impacted Business Parameters for a Business Change-Event”, filed on Nov. 13, 2009, the application being assigned to the assignee of the present application.

### FIELD

In general, embodiments of the invention relate to methods, systems, apparatus and computer program products for identifying probable impacted business parameters for a business change-event and, more particularly, identifying probable impacted business parameters, such as business applications, business teams and the like at the onset of a business change event, such as business project, initial product/service offering or the like.

### BACKGROUND

At the onset of business change-events, such as business projects, product/service development/launch and the like, impacted business parameters, such as business applications, business teams/organizations are typically identified, so that proper planning can transpire. In today's business environment, identification of these impacted business parameters is a manual process. In this regard, a business change event is typically initiated by business associates documenting high-level, business ideas for subsequent technology review. Based on their knowledge base, these business associates may or may not identify possible impacted business parameters, such as business applications. Business teams/organizations or the like. In the current environment, specific individuals within a team/organization are engaged to assess whether their team/organization and/or applications associated with their team/organization may be impacted by change-event and/or the order of magnitude (i.e., level) of the impact.

However, the current manual process has various limitations and drawbacks. Besides being a highly inefficient process that adds to the overall cycle-time of the change-event, the manual process is highly susceptible to oversights. The business associate must possess requisite business knowledge of the impacted business parameters and/or have access to and be able to provide a quality interpretation of business documentation in order to insure that probable impacted business parameters are identified. If the manual process fails to identify an impacted business parameter, such as a business application, team or the like, at the onset of the change-event, a subsequent change control process must be implemented to identify and secure necessary resources during the processing stage of the change-event. Typically, change control processes further increase cycle time of the change event and provide for additional costs.

In addition to manually identifying the probable impacted business parameters, additional time and resources may be allocated to determining the level-of-impact/order of magnitude of the probable impacted business parameters. The level-of-impact/order of magnitude is essential in determining the viability of a change-event, i.e., business project or the like, from a technology cost perspective. Manual initiatives, such as standard estimation processes are typically implemented at the planning stage to determine the order of magnitude of impacted business parameters.

Therefore, a need exists to develop systems, methods and the like for automating the identification of impacted business parameters at the onset of a business change-event, such as a business project or the like. The automated aspect of the invention should eliminate the need to manually identify impacted business parameters, such as applications, teams or the like, thus significantly improving overall cycle-time for the change-event. Additionally, by eliminating manual identification of impacted business parameters, errors due to oversights or lack of knowledge are eliminated and non-scope related change control processes are lessened. Additionally, cost savings may be realized by forgoing the need to engage team associates to identify impacted business parameters.

Moreover, a further need exists to develop systems, methods and the like for automating the determination of level-of-impact/order of magnitude of probable impacted business parameters associated with a change-event. Such, automated aspects should further increase cycle time of the change event by reducing the volume of change-events sent though a standard estimation process for planning change-events.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention relate to systems, apparatus, methods, and computer program products for identifying probable impacted business parameters, such as business applications, business teams/organizations or the like, at the onset of a business change-event, such as a business project, initiation of product/service offering or the like. A predefined statistical model is implemented to analyze historical data and architecture blueprints to determine probable impacted business parameters. Additionally, embodiments provide for grading the likelihood of impact, determining the level-of-impact, in terms of hours and financials and/or prioritizing the probable impacted business parameters. In addition, embodiments provide for automated notification of individuals and/or entities associated with the probable impacted business parameters, such as business applications, business teams/organizations or the like.

A method for determining impacted business parameters for a business change-event defines a first embodiment of the invention. The method includes receiving, at a computing device, business change-event scope-related information and determining, at a computing processor, probable impacted business parameters associated with the business change-event based on the business change-event scope-related information and historical business change-event data. The method further includes storing, in a computing memory, the probable impacted business parameters associated with the business change-event.

In specific embodiments of the method, determining further includes determining, at the computing processor, probable impacted business applications associated with the business change-event based on the business change-event scope related information and historical business change-event data related to applications impacted by previous change-events. In other specific embodiments of the method determining further includes determining, at the computing processor, probable impacted business teams/organizations associated with the business change-event based on the business change-event scope related information and historical business change-event data related to business teams/organizations impacted by previous change-events. In still other specific embodiment of the method, determining further includes determining, at a computing processor, probable impacted business parameters associated with the business change-event based on the business change-event scope-related information, the historical business change-event data and one or more business change-event architecture blueprints. In further such embodiments, determining may further include determining, at the computing processor, probable impacted business parameters associated with the business change-event based on a predefined statistical model that analyzes the historical change-event data and the one or more business change-event architecture blueprints that reflect the current network infrastructure environment.

In other embodiments of the invention receiving further includes receiving, at the computing device, business change-event scope-related information, wherein the business change-event scope-related information is defined as one or more of perceived customers impacted, perceived training impacted, perceived applications impacted, perceived business associates impacted, perceived infrastructure impacted, perceived geographic regions impacted, perceived lines of business or other impact information.

Additionally, other specific embodiments of the method may further include generating, at a computing device, a listing of the probable impacted business parameters, wherein the listing provides for a grading or categorization of the likelihood of the probable impact.

In still further specific embodiments the method may include generating and initiating communication of, at a computing device, electronic communication notifications that notify designated parties of the probable impacted business parameters.

In other specific embodiments the method may include determining, at a computing processor, a level-of-impact for the probable impacted business parameters based on historical business change-event data and business change-event criteria. In such embodiments, determining a level-of-impact may include determining an estimated time of use impact for each of the probable business parameters based on historical business change-event data and business change-event criteria and/or determining an estimated financial impact for the probable impacted business parameters based on historical business change-event data, the estimated time of use for each of the probable business parameters and a rate for each of the probable impacted business parameters.

An apparatus for determining impacted business parameters for a business change-event provides for another embodiment of the invention. The apparatus includes a computing device including at least one processor and a memory. The apparatus also includes a business parameter impact determining tool stored in the memory and executable by the at least one processor. The tool is configured to receive business change-event scope-related information defined as one or more of perceived customers impacted, perceived training impacted, perceived applications impacted, perceived business associates impacted, perceived infrastructure impacted, perceived geographic regions impacted, perceived lines of business or other impact information. The tool also includes business parameter impact logic configured to determine probable impacted business parameters, such as business application, business teams or the like, associated with the business change-event based on the business change-event scope-related information and historical business change-event data.

According to specific embodiments of the apparatus, the business parameter impact-logic is further configured to determine probable impacted business parameters associated with the business change-event based on the business change-event scope-related information, the historical business change-event data and one or more business change-event architecture blueprints that reflect the current network infrastructure environment.
In further such embodiments, the business parameter impact-logic is further configured to determine probable impacted business parameters associated with the business change-event based on a predefined statistical model that analyzes the historical change-event data and the one or more business change-event architecture blueprints that reflect the current network infrastructure environment.

In other specific embodiments of the apparatus, the business parameter impact determining tool further includes impacted business parameter listing logic configured to generate a listing of the probable impacted business parameters, wherein the listing provides for a grading of the likelihood of the probable impact. In still other specific embodiments of the apparatus, the business parameter impact determining tool further includes impacted business parameter notification logic configured to generate and initiate communication of electronic communication notifications that notify designated parties of the probable impacted business parameters.

In still further specific embodiments of the apparatus, the business parameter impact determining tool further includes business parameter level-of-impact logic configured to determine a level-of-impact for the probable impacted business parameters based on historical business change-event data and business change-event criteria. In one such embodiment, the business parameter level-of-impact logic is further configured to determine an estimated time of use impact for each of the probable business parameters based on historical business change-event data and business change-event criteria. In still further related embodiments, the business parameter level-of-impact logic is further configured to determine an estimated financial impact for the probable impacted business parameters based on historical business change-event data, the estimated time of use for each of the probable business parameters and a rate for each of the probable impacted business parameters.

According to other specific embodiments of the apparatus, the business parameter impact determining tool further includes business parameter impact priority logic configured to determining priority of the probable impacted business parameters based on received business-change event component data.

Yet another embodiment of the invention is defined by a computer program product that includes a computer-readable medium. The medium includes a first set of codes for causing a computer to receive business change-event scope-related information. Additionally, the medium includes a second set of codes for causing a computer to determine probable impacted business parameters associated with the business change-event based on the business change-event scope-related information and historical business change-event data. Also the medium includes a third set of codes for causing a computer to store the probable impacted business parameters associated with the business change-event.

Another method for determining the level-of-impact of business parameters for a business change-event defines yet another embodiment of the invention. The method includes receiving, at a computing device, business change-event criteria and probable impacted business parameters, such as business applications, business teams/organizations or the like, associated with the business change-event. The method further includes determining, at a computing processor, a level-of-impact for the probable impacted business parameters based on historical business change-event data and the business change-event criteria. Additionally the method includes storing, at computing memory, the level-of-impact for the probable impacted business parameters.

In specific embodiments of the method, determining further includes determining an estimated time of use impact for each of the probable business parameters based on the historical business change-event data and business change-event criteria. In related specific embodiments, determining further includes determining an estimated financial impact for the probable impacted business parameters based on the historical business change-event data, the estimated time of use for each of the probable business parameters and a rate for each of the probable impacted business parameters.

Yet another apparatus for determining level-of-impact for business parameters for a related business change-event provides for another embodiment of the invention. The apparatus includes a computing device including at least one processor and a memory. The apparatus additionally includes a business parameter level-of-impact tool stored in the memory and executable by the at least one processor. The tool is configured to receive business change-event criteria and probable impacted business parameters, such as business application, business teams/organizations or the like, associated with the business change-event, Additionally, the tool includes business parameter level-of-impact logic configured to determine level-of-impact for the probable impacted business parameters based on historical business change-event data and the business change-event criteria.

In specific embodiments of the apparatus, the business parameter level-of-impact logic is further configured to determine an estimated time of use impact for each of the probable business parameters based on the historical business change-event data and business change-event criteria. In related specific embodiments, the business parameter level-of-impact logic is further configured to determine an estimated financial impact for the probable impacted business parameters based on the historical business change-event data, the estimated time of use for each of the probable business parameters and a rate for each of the probable impacted business parameters.

Moreover, another computer program product that includes a computer-readable medium provides another embodiment of the invention. The computer program product includes a first set of codes for causing a computer to receive business change-event criteria and probable impacted business parameters associated with the business change-event. The medium also includes a second set of codes for causing a computer to determine a level-of-impact for the probable impacted business parameters based on historical business change-event data and the business change-event criteria. Additionally, the medium includes a third set of codes for causing a computer to store the level-of-impact for the probable impacted business parameters.

Thus, systems, apparatus, methods, and computer program products described in detail below provide for identifying probable impacted business parameters, such as business applications, business teams/organizations or the like, at the onset of a business change-event, such as a business project, launch of product/service or the like.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of an apparatus for identifying probable impacted business parameters, in accordance with embodiments of the present invention;

FIG. 2 is a block diagram of apparatus for identifying a level-of-impact for business parameters, in accordance with embodiments of the present invention;

FIG. 3 is a detailed block diagram of an apparatus for identifying probable impacted business parameters, in accordance with another embodiment of the invention;

FIG. 4 is a flow diagram of a method for determining probable impacted business parameters, in accordance with embodiments of the present invention;

FIG. 5 is a flow diagram of a method for determining probable impacted business parameters including optional processing, in accordance with an embodiment of the present invention;

FIG. 6 is a flow diagram of a method for determining business parameter level-of-impact, in accordance with embodiments of the present invention;

FIG. 7 is a block diagram depiction of a general business and change-event information components used for identifying probable impacted business parameters, in accordance with embodiments of the present invention;

FIG. 8 is a block diagram of business change-event scope information used to identify probable impacted business parameters, in accordance with embodiments of the present invention; and

FIG. 9 is a block diagram of financial impact determination of probable impacted business parameters, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, infrared, or semiconductor system, apparatus, device, or propagation medium. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device; or transmission media such as those supporting the Internet or an intranet. Note that the computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, present embodiments herein disclosed provide for identifying probable impacted business parameters, such as business applications, business teams/organizations or the like, at the onset of a business change-event, such as a business project, initiation of product/service offering or the like. A predefined statistical model is implemented to analyze historical data and architecture blueprints to determine probable impacted business parameters. In this regard, the probable nature of the impacted business parameters becomes more accurate over time (i.e., a self-learning aspect) as more historical data becomes available. Additionally, embodiments provide for grading or otherwise categorizing the likelihood of impact of the business parameters. In addition, embodiments provide for automated notification of individuals and/or entities associated with the probable impacted business parameters.

Additionally, alternate embodiments provide for determining the level-of-impact, in terms of hours and financials by estimating the order of magnitude of the business change-event, in terms of man-hours, hours of use or the like, based on the historical data and project criteria. Once the order of magnitude is estimated, an appropriate rate or the like may be applied to estimate the financial level-of-impact of the business change-event.

In other embodiments, other business components related to the project may be captured to assess their relationship to technology and to further prioritize and/or narrow down the list of probable impacted business parameters.

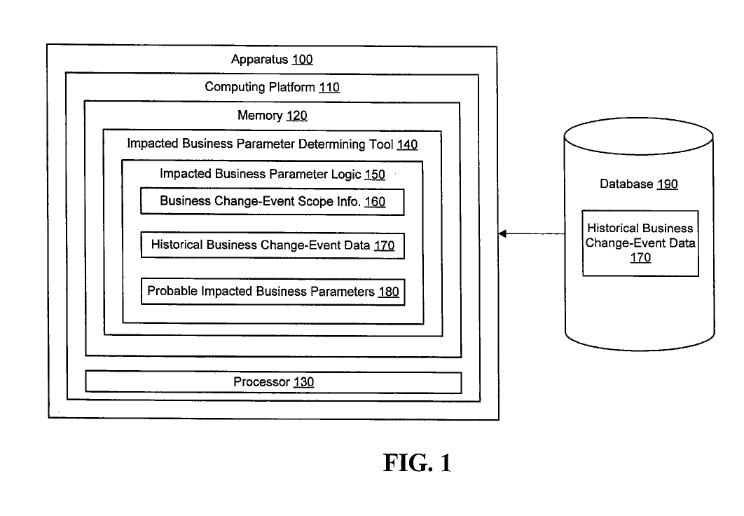

Referring to FIG. 1 a block diagram is depicted of an apparatus 100 configured for identifying probable impacted business parameters, such as business applications (e.g. software or the like), business teams/organizations or the like, in accordance with embodiments of the present invention. The apparatus includes a computing platform 110, which includes a memory 120 and processor 130. The memory 120 includes an impacted business parameter determining tool/module 140 that is executable by the processor 130. The impacted business parameter determining tool/module 140 is configured to determine probable impact business parameters at the onset of a business change-event, such as a business project, launch of a product/service or the like.

As such, impacted business parameter determining tool/module 140 includes impacted business parameter logic 150. The logic 150 is configured to receive business change-event scope information 160, such as perceived customers impacted by the change-event, perceived training impacted by the change-event, perceived applications impacted by the change-event, perceived impacted business associates, perceived impacted technical infrastructure, perceived impacted geographic regions, perceived impacted lines of business and any other impact-related data. In specific embodiments of the invention, the impacted business parameter determining tool/module 140 is configured to provide a user interface, such as Graphical User Interface (GUI) that allows a user to input requisite business change-event scope information 160. The user interface may be a network-accessible user interface, such as an Internet or intranet-accessible interface. In addition to providing for business change-event scope information 160 user input, the user interface may additionally provide for a user to input general business change-event information, such as change-event identifying information or the like, which serves to link the scope information 160 to the change-event.

Based on the business change-event scope information 160, the impacted business parameter logic 150 is configured to perform analysis on historical business change-event data 170 to determine probable impacted business parameters 180, such as probable impacted business applications, probable impacted business teams/organizations or the like. The historical business change-event data is compiled and stored at an external database 190 and includes data related to business parameters implemented or otherwise used in previous business-change events. In specific embodiments of the invention the impacted business parameter logic 150 implements a predefined statistical model based on the historical business change-event data 170 to determine via heuristical analysis the probable impacted business parameters 180.

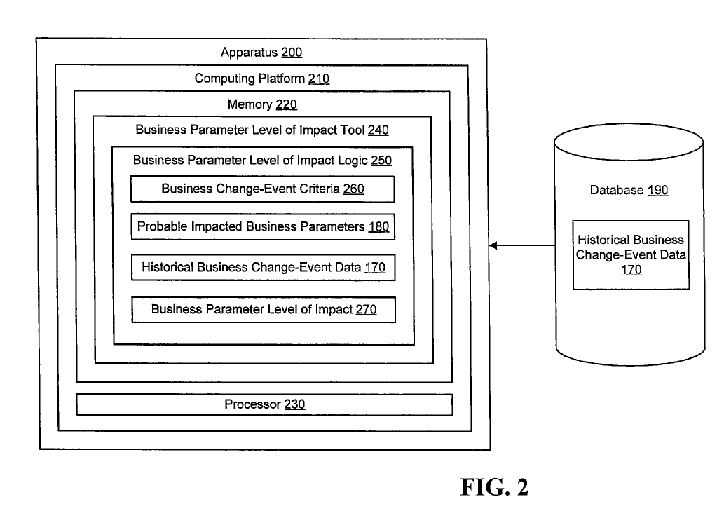

Referring to FIG. 2, a block diagram is depicted of an apparatus 200 configured for identifying the level-of-impact for probable impacted business parameters, in accordance with embodiments of the present invention. Similar to the apparatus 100 shown in FIG. 1, the apparatus 200 includes a computing platform 210, which includes a memory 220 and processor 230. The memory 120 includes business parameter level-of-impact tool/module 240 that is executable by the processor 230. The business parameter level-of-impact tool/module 240 is configured to determine an estimated level-of-impact for probable impacted business parameters associated with a business change-event, such as a business project, launch of a product/service or the like. The level-of-impact may be defined by amount of use of the business parameters for the specific change event, for example, the estimated hours of use for a business application or the estimated man-hours for the business team/organization. Additionally, level-of-impact may be defined by the financial impact of the business parameters for the specific change event, for example, the cost of use of the business application or the cost of use the business team/organization.

The business parameter level-of-impact tool/module 240 includes business parameter level-of-impact logic 250. The logic 250 is configured to receive business change-event criteria 260 and probable impacted business parameters 180. In specific embodiments of the invention, the business parameter level-of-impact tool/module 240 is configured to provide a user interface, such as Graphical User Interface (GUI) that allows a user to input requisite business change-event criteria 260. The user interface may be a network-accessible user interface, such as an Internet or intranet-accessible interface. The applicable business change-event criteria 260 may include, but is not limited to, impacted business channels, impacted products and the like. In one example, in which the business entity is a financial institution, the impacted business channels may include banking centers, Automated Teller Machines (ATMs), online banking and the like and the impacted products may include checking accounts, savings accounts, Individual Retirement Accounts (IRAs), Certificates of Deposit (CDs), credit accounts/cards and the like. In certain embodiments, the business change event criteria 260 may be expandable bases on business entity needs and the like. While in most embodiments of the invention, the probable impacted business parameters 180 result from the apparatus 100 shown and described in FIG. 1, in further embodiments the probable impacted business parameters 180 used to determine level-of-impact may be identified and/or determined in any other feasible manner.

Based on the business change-event criteria 260 and the probable impacted business parameters, the business parameter level-of-impact logic 250 is configured to perform analysis on historical business change-event data 170 to determine business parameter level-of-impact 270, such as time of use and/or cost of the probable impacted business applications, the business teams/organizations or the like. The historical business change-event data is compiled and stored at an external database 190 and includes data related to business parameters implemented or otherwise used in previous business-change events.

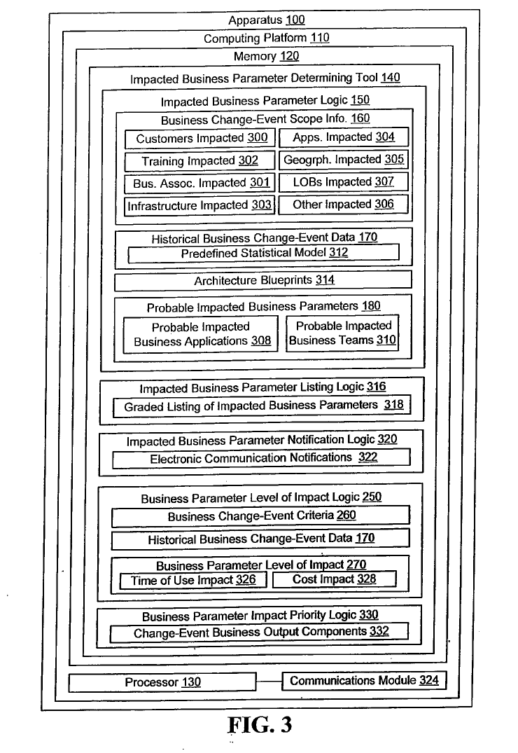

FIG. 3 provides a more detailed depiction of an apparatus 100, according to further embodiments of the present invention. In addition to providing greater detail, FIG. 3 highlights various optional components/embodiments not shown in FIGS. 1 and/or 2. The apparatus 100 may include any type and/or combination of one or more computing devices, such as servers, personal computers, or the like. The apparatus 100 includes computing platform 110 that is operable to receive and execute modules, routines and applications, such as impacted business parameter determining tool/module 140 or the like. Computing platform 110 includes memory 120, which may comprise volatile and nonvolatile memory such as read-only and/or random-access memory (RAM and ROM), EPROM, EEPROM, flash cards, or any memory common to computing platforms. Further, memory 120 may include one or more flash memory cells, or may be any secondary or tertiary storage device, such as magnetic media, optical media, tape, or soft or hard disk.

Further, computing platform 110 also includes processor 130, which may be an application-specific integrated circuit (“ASIC”), or other chipset, processor, logic circuit, or other data processing device. Processor 130 or other processor such as ASIC may execute an application programming interface (“API”) layer that interfaces with any resident programs, such as impacted business parameter determining tool/module 140 or the like, stored in the memory 120 of apparatus 100.

Processor 130 includes various processing subsystems embodied in hardware, firmware, software, and combinations thereof, that enable the functionality of apparatus 100 and the operability of the apparatus on a network. For example, processing subsystems allow for initiating and maintaining communications, and exchanging data, with other networked devices. It should be noted that any of the tools, modules, sub-modules, and routines shown and described as being in memory 120 may alternatively be embodied in processing subsystems.

The memory 120 of apparatus 100 includes the aforementioned impacted business parameter determining tool/module 140 configured to determine probable impact business parameters, such as business applications, business teams and the like, at the onset of a business change-event, such as a business project, launch of a product/service or the like. The impacted business parameter determining tool/module 140 includes impacted business parameter logic 150. The logic 150 is configured to receive business change-event scope information 160, which may include one or more of perceived customers impacted 300, perceived training impacted 302, perceived applications impacted 304, perceived business associated impacted 301, perceived infrastructure impacted 303, perceived geographic regions impacted 305 and perceived lines of business (LOBs) impacted 307 and any other impact-related data 306.

Based on the business change-event scope information 160, the impacted business parameter logic 150 is configured to perform analysis on historical business change-event data 170 to determine probable impacted business parameters 180, such as probable impacted business applications 308, probable impacted business teams/organizations 310 or the like. In specific embodiments of the invention the impacted business parameter logic 150 implements a predefined statistical model 312 based on the historical business change-event data 170 to determine via heuristical analysis the probable impacted business parameters 180.

In addition to determining probable impacted business parameters 180 based on the business change-event scope information 160 and analysis of the historical business change-event data 170, alternate embodiments of the invention further include analysis of one or more architecture blueprints 314 in the determination of the probable impacted business parameters 180. An architecture blueprint 314 as defined herein is a planning and strategy document used to capture the computing environment of the change-event/project. Thus, the analysis may include one or more architecture blueprints 314 of the current network infrastructure environment or the like. Thus, in such embodiments, the impacted business parameter logic 150 determines probable impacted business parameters 180 based on the business change-event scope information 160 and analysis of one or more architecture blueprints 314 and historical business change-event data 170, such as through the implementation of statistical model 312.

The impacted business parameter determining tool/module 140 may optionally include impacted business parameter listing logic 316 that is configured to generate an automated listing of the probable impacted business parameters associated with the change-event. The automated listing is typically provided to the user via user interface application, such as a network-accessible Graphical User Interface (GUI) or the like. In specific embodiments of the invention, the impacted business parameter listing logic 316 is configured to generate a graded listing of the probable (i.e., most likely) impacted business parameters 318. In specific embodiments, grading may be accomplished by color-coding or otherwise designating business parameters in the listing. For example, specific colors/designators may categorize business parameters as highly likely to be impacted, less likely to be impacted, not likely to be impacted and the like. Additionally, color-coding or other designators may be implemented to show an impact relationship between two or more business parameters (i.e., an impact pattern). For example, if application “x” is impacted, it is highly likely that applications “y” and “z” are also impacted and the like. Grading may also comprise a numerical scoring of the likelihood that a business parameter is impacted or any other acceptable grading mechanism may be implemented.

Additionally, impacted business parameter determining tool/module 140 may optionally include impacted business parameter notification logic 320 that is configured to generate and initiate electronic communication of notifications/alerts 322. The alerts/notifications 322 are configured to be electronically communicated, via communications module 324, to designated individuals/teams or the like based on determination of the probable impacted business parameters 180. The notifications/alerts serve to notify the designated individuals, teams or the like, of the probable impacted business parameters 180 that are associated with the individual and/or team. The alerts/notifications may be electronic-mail communications, Short Message Service (SMS)/text communications, or the like.

The impacted business parameter determining tool/module 140 may additionally include business parameter level-of-impact logic 250. While business parameter level-of-impact logic 250 is shown and discussed in relation to a stand-alone tool/module 240 embodied in apparatus 200 of FIG. 2, business parameter level-of-impact logic 250 may, in other embodiments, be included as a component within impacted business parameter determining tool/module 140.

The business parameter level-of-impact logic 250 is configured to receive business change-event criteria 260 and probable impacted business parameters 180 and determine level-of-impact 270 based on the criteria 260, the probable impacted business parameters 180 and analysis of historical business change-event data. The applicable business change-event criteria 260 may include, but is not limited to, impacted business channels, impacted products and the like. In one example, in which the business entity is a financial institution, the impacted business channels may include banking centers, Automated Teller Machines (ATMs), online banking and the like and the impacted products may include checking accounts, savings accounts, Individual Retirement Accounts (IRAs), Certificates of Deposit (CDs), credit accounts/cards and the like. In certain embodiments, the business change event criteria 260 may be expandable bases on business entity needs and the like. The business parameter level-of-impact 270 may include, but is not limited to, estimated time of use impact 326 and/or estimated cost impacted 328 of the probable impacted business applications, the business teams/organizations or the like. For business applications, time of use may be reflected in hours of use, days of use or the like and for business teams time of use may be reflected in man-hours, man-days or the like. In certain embodiments, estimated cost impact may be determined by applying a cost rate to the estimated time of use.

In addition, impacted business parameter determining tool/module 140 may include business parameter impact priority logic 330 that is configured to prioritize the probable impacted business parameters 180 or otherwise narrow the volume of probable impacted business parameters based on change-event business output components 332, such as channels affected by the change-event, price increase/decrease of a product/service affected by the change-event, other products or services affected by the change-event and the like. In one specific embodiment, a user is queried with a plurality of questions related to change-event, line of business and/or product/service being developed or revised. The users answers to these queries are them associated with the probable impacted business parameters to prioritize and/or narrow the volume of probable impacted business parameters 180.

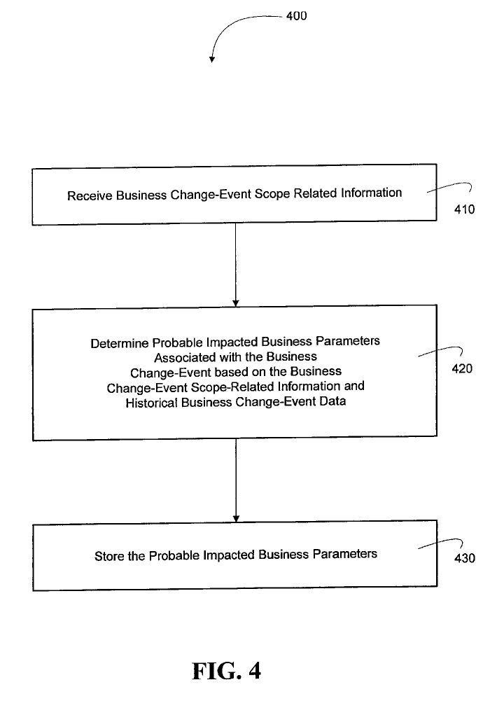

Turning the reader's attention to FIG. 4, a flow diagram is illustrative of a method 400 for determining probable impacted business parameters associated with a business change-event, in accordance with an embodiment of the invention. At Event 410, business change-event scope related information is received at a computing device. The scope related information may include, but is not necessarily limited to, perceived customer impact information, perceived training impact information, perceived application impact information, perceived business associated impacted, perceived infrastructure impacted, perceived geographic regions impacted, perceived lines of business impacted and any other perceived impact information related to technology or the like. The business change-event scope related information may be received based on user input to a network-accessible GUI application or the like. In addition, general business change-event information components may be received which serve to identify the business change-event and provide a link between the change-event and the scope related information.

At Event 420, probable impacted business parameters, such as business application, business teams/organizations or the like, associated with a business change-event, such as a business project or the like, are determined by a computing device processor. The probable impacted business parameters are determined based on the business change-event scope information and historical business change-event data. In optional embodiments, the determination of the probable impacted business parameters may be further based on architecture blueprints that reflect the current network infrastructure environment.

In accordance with specific embodiments of the method, predefined statistical models are implemented to analyze the historical business change-event data as a means of determining the probable impacted business parameters.

At Event 430, the determined probable impacted business parameters are stored in computing device memory.

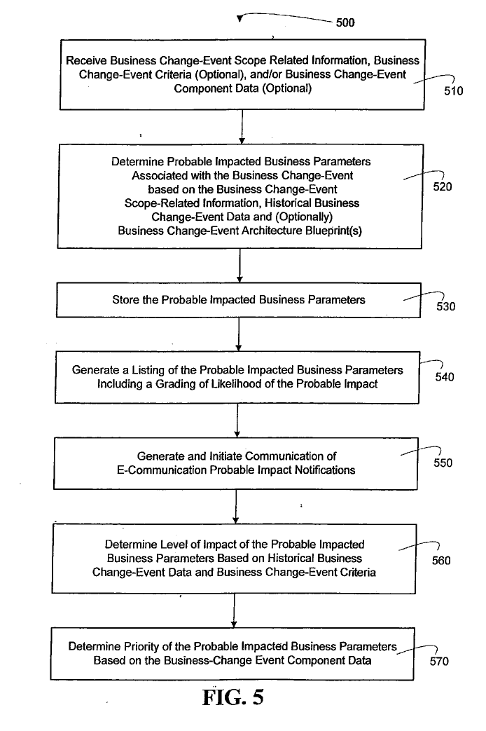

Referring to FIG. 5, a flow diagram of an alternate method 500 for determining probable impacted business parameters and level-of-impact is depicted, in accordance with embodiments of the present invention. Events 510, 520 and 530 are equivalent to Events 410, 420 and 430 of the method shown in FIG. 4 and the description provided previously in relation to FIG. 4 is equally applicable to FIG. 5. Hence, for the sake of brevity, the discussion of Events 510, 520 and 530 is not repeated at this time.

Further, at Event 540, a listing is generated of the probable impacted business parameters. The listing may include a grading of the likelihood of the probable impact and/or a grading of likely impact relationships/patterns. The grading may comprise color-coding or some other designators/identifiers that correlate to a classification of impact, such as highly likely impacted, less likely impacted, not likely impacted and the like. In other embodiments, a numerical score or an alphabetic grade may be assigned to a business parameter to denote the likelihood of the probable impact. The likelihood of probable impact may be deduced from the historical business change-event data or the like. The listing may be network communicated and displayed to a user via a user interface application, such as a GUI application or the like.

At Event 550, probable impact notifications/alerts are generated and electronic communication of the notifications/alerts to designated individuals/teams is initiated. The notifications serve to notify designated individuals and/or teams associated with the impacted business parameter. The system may be configured to automatically generate and communicate the notifications/alerts to the designated individuals/teams or, in other embodiments, a user may provide inputs to generate and initiate the notifications/alerts to designated or user-identified individuals/teams.

At Event 560, the level-of-impact/order of magnitude for the probable impacted business parameters is determined. The level-of-impact may be defined as a time of use impact and/or a cost impact. In specific embodiments, the level-of-impact is determined based on business change-event criteria, such as cost rates for the change-event and historical business change-event data that provide for estimating the time inputs for the probable impacted business parameters.

At Event 570, priority of the probable impacted business parameters is determined based on the business-change event component data. The applicable business change-event component data may include, but is not limited, to output channels, price impact, related products/services and the like. In addition to, or in lieu of determining priority, the list of probable impacted business parameters may be narrowed down based on the applicable business change-event component data.

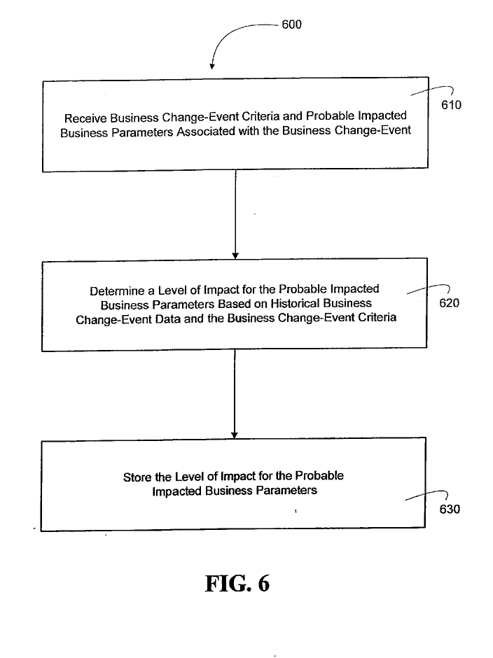

FIG. 6 is a flow diagram depicting a method 600 for determining level-of-impact/order of magnitude of impacted business parameters associated with a business change-event, in accordance with an embodiment of the invention. At Event 610, business change-event criteria and probable impacted business parameters are received at a computing device. The business change-event criteria may include, but is not limited to, impacted business channels, impacted products and the like. The business change-event criteria information may be received based on user input to a network-accessible GUI application or the like. The probable impacted business parameters may be determined based on business change-event scope-related information and analysis of historical business change-event data and, optionally, architecture blueprints that reflect the current network infrastructure environment.

At Event 620, a level-of-impact is determined for the probable impacted business parameters by a computing device processor. The level-of-impact/order of magnitude may be defined in terms of time of use impact and/or cost impact. The level-of-impact/order of magnitude is determined based on the business change-event criteria and historical business change-event data. In optional embodiments, the determination of the level-of-impact may be further based on architecture blueprints that reflect the current network infrastructure environment.

In accordance with specific embodiments of the method, predefined statistical models are implemented to analyze the historical business change-event data as a means of determining the level-of-impact.

At Event 630, the determined level-of-impact of the probable impacted business parameters is stored in computing device memory.

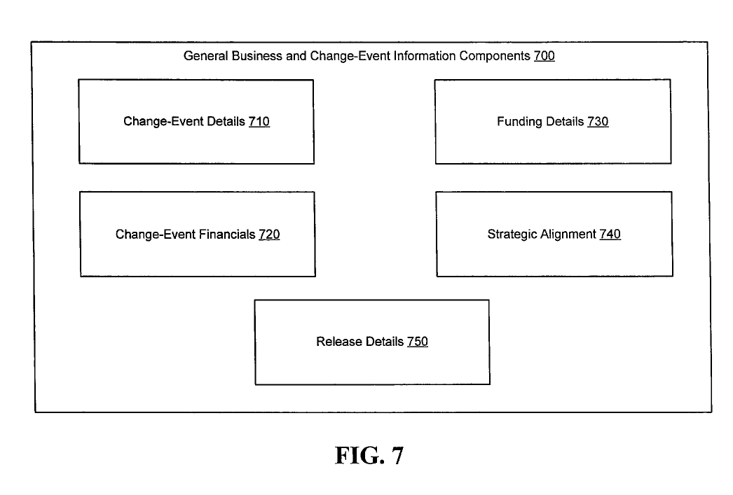

FIG. 7 provides a block diagram of general business and change-event information components 700 that may be inputted, in conjunction with business change-event scope-related information to determine probable impacted business parameters, in accordance with embodiments of the present invention. In specific embodiments of the invention, a Graphical User Interface (GUI) application is provided that allows network access to the business and change-event information component inputs. The business and change-event information component inputs may provide for a user to make text inputs and/or select inputs, such as from pull-down menus or the like. The general business and change-event information components 700 may include one or more of change-event details 710, change-event financials 720, funding details 730, strategic alignment 740 and release details 750.

Change-event details 710 include user inputs for change-event name, change-event-associated numbers, change-event type, complexity metric, work effort, change-event description and the like. Change-event financials 720 include user inputs for estimated revenue, estimated net income before taxes (NIBT), value added term, change-event expenses (estimated, budgeted and actuals); with expenses broken down by labor, infrastructure, direct, reserve and total and the like

Funding details 730 may include user inputs for funding tier, funding type, one or more funding sponsors and the like. Strategic alignment 740 may include user inputs for strategic alignment numbers, a text field for describing strategic alignment; portfolio alignment, program alignment and the like. Release details 750 may include a projected deployment date, a release to line-of-business date, release event, release track, release type and release start.

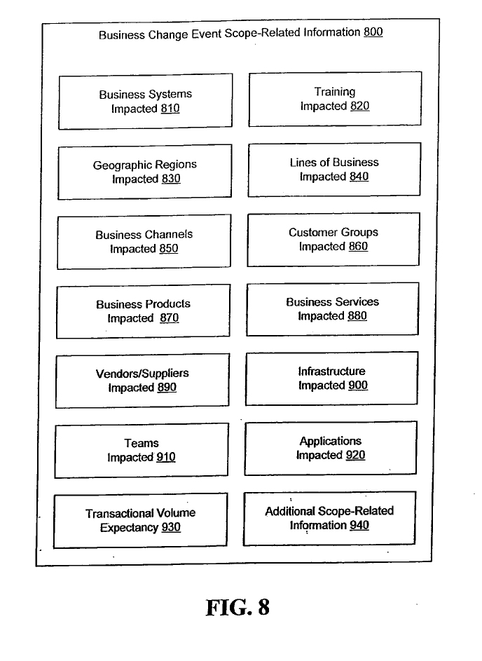

FIG. 8 provides a block diagram of business change-event scope-related information 800 may be inputted to determine probable impacted business parameters, in accordance with embodiments of the present invention. In specific embodiments of the invention, a Graphical User Interface (GUI) application is provided that allows network access to the business change-event scope-related inputs. The business change-event scope-related information 800 may provide for a user to make text inputs and/or select inputs, such as from pull-down menus or the like. The business change-event scope-related information 800 may include one or more of perceived business systems impacted 810, perceived training impacted 820, perceived geographic regions impacted 830, perceived line-of-business impacted 840, perceived business channels impacted 850, perceived customer groups/segments impacted 860, perceived business projects impacted 870, perceived business services impacted 880, perceived vendors/suppliers impacted 890, perceived infrastructure impacted 900, perceived teams impacted 910, perceived applications impacted 920 transactional volume expectancy 930 and additional scope-related information 940. In addition to serving as the basis for determining probable impacted business parameters, one or more of the business change-event scope-related information may be included in the business change-event criteria used to determine level-of-impact of the probable impacted business parameters.

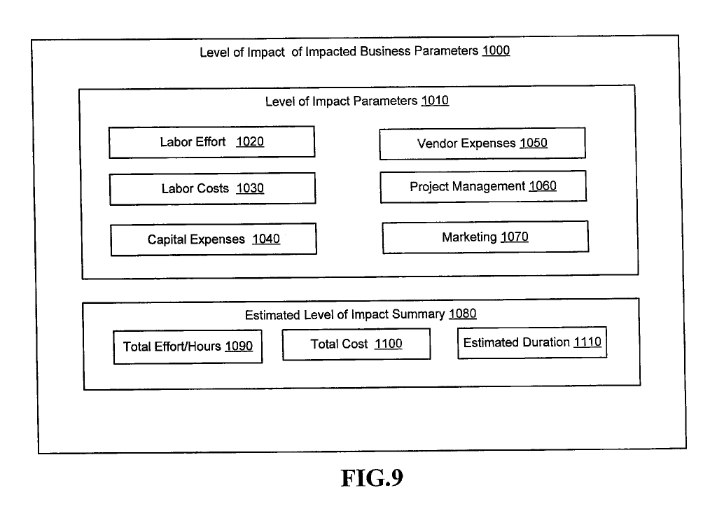

FIG. 9 provides a block diagram of a level-of-impact of impacted business parameters 1000 tool, in accordance with an embodiment of the present invention. In specific embodiments of the invention, a Graphical User Interface (GUI) application is provided that allows network access to the level-of-impact inputs. The level-of-impact inputs may provide for a user to make numerical inputs and text inputs for assumptions related to level-of-impact parameters 1010. In one specific embodiment sliding-bar type user inputs are provided for the user to estimate and modify an estimated level-of-impact parameter 1010. The level-of-impact parameters may include one or more of estimated labor effort 1020, defined in terms of hours; estimated labor costs 1030, defined in terms of dollars; estimated capital expenses 1040, defined in terms of dollars; estimated vendor/supplier expenses 1050, defined in terms of dollars; estimated project management costs 1060, defined in terms of dollars, estimated marketing costs 1070, defined in terms of dollars and the like.

Based on inputted level-of-impact parameters 1010 and historical change-event data, estimated level-of-impact summary data 1080 results. The summary data may include total effort 1090, defined in terms of man-hours; total cost 1100, defined in terms of dollars; estimated duration of the change-event 1110, defined in terms of days or the like, and any other estimated level-of-impact data.

Thus, systems, apparatus, methods, and computer program products herein described provide for identifying probable impacted business parameters, such as business applications, business teams/organizations or the like, at the onset of a business change-event, such as a business project, initiation of product/service offering or the like. A predefined statistical model is implemented to analyze historical data and architecture blueprints to determine probable impacted business parameters. In this regard, the probable nature of the impacted business parameters becomes more accurate over time (i.e., self-learning) as more historical data becomes available. Additionally, embodiments provide for determining the level-of-impact, in terms of hours and financials and/or the priority of the probable impacted business parameters. In addition, embodiments provide for automated notification of individuals and/or entities associated with the probable impacted business parameters.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. An apparatus for determining impacted business parameters for a business change-event, the apparatus comprising:
a computing device including at least one processor and a memory; and
a business parameter impact determining tool stored in the memory, executable by the at least one processor and configured to receive business change-event scope-related information, and wherein the tool includes,
business parameter impact logic configured to determine probable impacted business software applications and probable impacted business teams associated with the business change-event based on the business change-event scope-related information and implementation of a predefined statistical model to analyze historical business change-event data related to software applications impacted by previous change-events and business teams impacted by previous change-events, and
business parameter level-of-impact logic configured to determine a level-of-impact for the probable impacted business software applications and probable impacted business teams based on historical business change-event data and business change-event criteria, wherein determining the level-of-impact includes determining (1) an estimated time of use impact for each of the probable business software applications and probable impacted business teams based on historical business change-event data and business change-event criteria, and (2) an estimated financial impact for the probable impacted business software applications and probable impacted business teams based on historical business change-event data, the estimated time of use for each of the probable business software applications and probable impacted business teams and an hourly rate for each of the probable impacted business software applications and probable impacted business teams.

2. The apparatus of claim 1, wherein the business parameter impact-logic is further configured to determine probable impacted business software applications and probable impacted business teams associated with the business change-event based on the business change-event scope-related information, the historical business change-event data and one or more business change-event architecture blueprints that reflect a current network infrastructure environment.

3. The apparatus of claim 1, wherein the business parameter impact determining tool is further configured to receive the business change-event scope-related information defined as one or more of perceived customers impacted, perceived training impacted, perceived business associated impacted, perceived infrastructure impacted, perceived geographic regions impacted, perceived lines of business impacted or perceived applications impacted.

4. The apparatus of claim 1, wherein the business parameter impact determining tool further comprises impacted business parameter listing logic configured to generate a listing of the probable impacted business software applications and probable impacted business teams, wherein the listing provides for a grading of a likelihood of a probable impact.

5. The apparatus of claim 1, wherein the business parameter impact determining tool further comprises impacted business parameter notification logic configured to generate and initiate communication of electronic communication notifications that notify designated parties of the probable impacted business software applications and probable impacted business teams.

6. The apparatus of claim 1, wherein the business parameter impact determining tool further comprises a business parameter impact priority logic configured to determining priority of the probable impacted business software applications and probable impacted business teams based on received business-change event component data.

7. A method for determining impacted business parameters for a business change-event, the method comprising:
receiving, by a computing device, business change-event scope-related information;
determining, by a computing device processor, probable impacted business software applications and probable impacted business teams associated with the business change-event based on the business change-event scope-related information and implementation of a predefined statistical model to analyze historical business change-event data related to software applications impacted by previous change-events and business teams impacted by previous change-events;
determining, by a computing device processor, a level-of-impact for the probable impacted business software applications and probable impacted business teams based on historical business change-event data and business change-event criteria, wherein determining the level-of-impact includes determining (1) an estimated time of use impact for each of the probable business software applications and probable impacted business teams based on historical business change-event data and business change-event criteria, and (2) an estimated financial impact for the probable impacted business software applications and probable impacted business teams based on historical business change-event data, the estimated time of use for each of the probable business software applications and probable impacted business teams and an hourly rate for each of the probable impacted business software applications and probable impacted business teams; and
storing, in a computing memory, the probable impacted business software applications associated with the business change-event, the probable impacted business teams associated with the business change-event and the level-of-impact for the probable impacted business software applications and probable impacted business teams.

8. The method of claim 7, wherein determining further comprises determining, by a computing device processor, probable impacted business software applications and probable impacted business teams associated with the business change-event based on the business change-event scope-related information, the historical business change-event data and one or more business change-event architecture blueprints that reflect a current network infrastructure environment.

9. The method of claim 7, wherein receiving further comprises receiving, by the computing device, business change-event scope-related information, wherein the business change-event scope related information is defined as one or more of perceived customers impacted, perceived training impacted, perceived applications impacted, perceived business associates impacted, perceived infrastructure impacted, perceived geographic regions impacted or perceived lines of business impacted.

10. The method of claim 7, further comprising generating, by a computing device processor, a listing of the probable impacted business software applications and probable impacted business teams, wherein the listing provides for a grading of a likelihood of a probable impact.

11. The method of claim 7, further comprising generating and communicating, by a computing device, electronic communication notifications that notify designated parties of the probable impacted business software applications and probable impacted business teams.

12. The method of claim 7, further comprising receiving, by a computing device, business-change event component data and determining, by a computing device processor, priority of the probable impacted business software applications and probable impacted business teams based on the business-change event component data.

13. A computer program product comprising:
a computer-readable medium comprising:
a first set of codes for causing a computer to receive business change-event scope-related information;
a second set of codes for causing a computer to determine probable impacted business software applications and probable impacted business teams associated with the business change-event based on the business change-event scope-related information and implementation of a predefined statistical model to analyze historical business change-event data related to software applications impacted by previous change-events and business teams impacted by previous change-events;
a third set of codes for causing a computer to determine a level-of-impact for the probable impacted business software applications and probable impacted business teams based on historical business change-event data and business change-event criteria, wherein determining the level-of-impact includes determining (1) an estimated time of use impact for each of the probable business software applications and probable impacted business teams based on historical business change-event data and business change-event criteria, and (2) an estimated financial impact for the probable impacted business parameters based on historical business change-event data, the estimated time of use for each of the probable business parameters and an hourly rate for each of the probable impacted business software applications and probable impacted business teams; and
a fourth set of codes for causing a computer to store the probable impacted business software applications associated with the business change-event, the probable impacted business teams associated with the business change-event and the level-of-impact for the probable impacted business software applications and probable impacted business teams.

14. The computer program product of claim 13, wherein the second set of codes is further configured to cause the computer to determine probable impacted business software applications and probable impacted business teams associated with the business change-event based on the business change-event scope-related information, the historical business change-event data and one or more business change-event architecture blueprints that reflect a current network infrastructure environment.

15. The computer program product of claim 13, wherein the first set of codes is further configured to cause the computer to receive the business change-event scope-related information defined as one or more of perceived customers impacted, perceived training impacted, perceived business associated impacted, perceived infrastructure impacted, perceived geographic regions impacted, perceived lines of business impacted or perceived applications impacted.

16. The computer program product of claim 13, further comprising a fourth set of codes for causing a computer to generate a listing of the probable impacted business software applications and probable impacted business teams, wherein the listing provides for a grading of a likelihood of a probable impact.

17. The computer program product of claim 13, further comprising a fourth set of codes for causing a computer to generate and initiate communication of electronic communication notifications that notify designated parties of the probable impacted business software applications and probable impacted business teams.

18. The computer program product of claim 13, further comprising a fourth set of codes for causing a computer to determine priority of the probable impacted business software applications and probable impacted business teams based on received business-change event component data.
